(19) United States
(12) Patent Application Publication
(10) Pub. No.: US 2011/0022429 A1
(43) Pub. Date: Jan. 27, 2011

(54) Resource reporting

(75) Inventors: Daniel J. Yates, Washington, DC (US); Alexander D. Laskey, Berkeley, CA (US)

Correspondence Address: Sunstein Kann Murphy & Timbers LLP, 125 SUMMER STREET, BOSTON, MA, 02110-1618, US

(73) Assignee: Positive Energy, Inc.

(21) Appl. No.: 12/009,622

(22) Filed: Jan. 18, 2008

Related U.S. Application Data
(60) Provisional application No. 61/008,955, filed on Dec. 21, 2007.

(51) Int. Cl. G06F 7/06; G06Q 10/00; G06F 17/30

(52) U.S. Cl. 705/7; 705/34; 707/E17.017

(57) ABSTRACT

A method of communicating a consumer's usage of a resource is disclosed. The consumer's usage of the resource is compared to usage of the resource by a relevant cohort that is not based solely on geography. A result of the comparison is communicated to the consumer.

### CROSS REFERENCE TO OTHER APPLICATIONS

This application claims priority to U.S. Provisional Patent Application No. 61/008,955 (Attorney Docket No. POSIP001+) entitled RESOURCE REPORTING filed Dec. 21, 2007 which is incorporated herein by reference for all purposes.

### BACKGROUND OF THE INVENTION

Persuading consumers to moderate their consumption of resources is useful to reduce the waste of said resources, to reduce overall or peak demand of said resources, to make efficient use of money, and to preserve the planet's natural environment. Resource distribution companies, such as utilities, have included reports in resource bills that attempt to persuade consumers to moderate their consumption based on a comparison with the same resource billing account (“resource account”) in a different year (e.g., you consumed X1 units as compared to X0 units for the same period last year), or with different resource accounts based on geography (e.g., you consumed Y(n) units as compared to an average consumption for the 415 area code of Y̅).

### BRIEF DESCRIPTION OF THE DRAWINGS

Various embodiments of the invention are disclosed in the following detailed description and the accompanying drawings.

FIG. 1 illustrates a system for communicating a consumer's usage of a resource.

FIG. 2 is a block diagram illustrating an embodiment of a system for communicating a consumer's usage of a resource.

FIG. 3 is a flowchart illustrating an embodiment of a process for communicating a consumer's usage of a resource.

FIG. 4 is a flowchart illustrating an embodiment of a process for determining a relevant cohort.

FIG. 5 is a flowchart illustrating an embodiment of a process for determining a relevant cohort candidate.

FIG. 6 is a flowchart illustrating an embodiment of a process for comparing a consumer's resource usage with a relevant cohort candidate.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

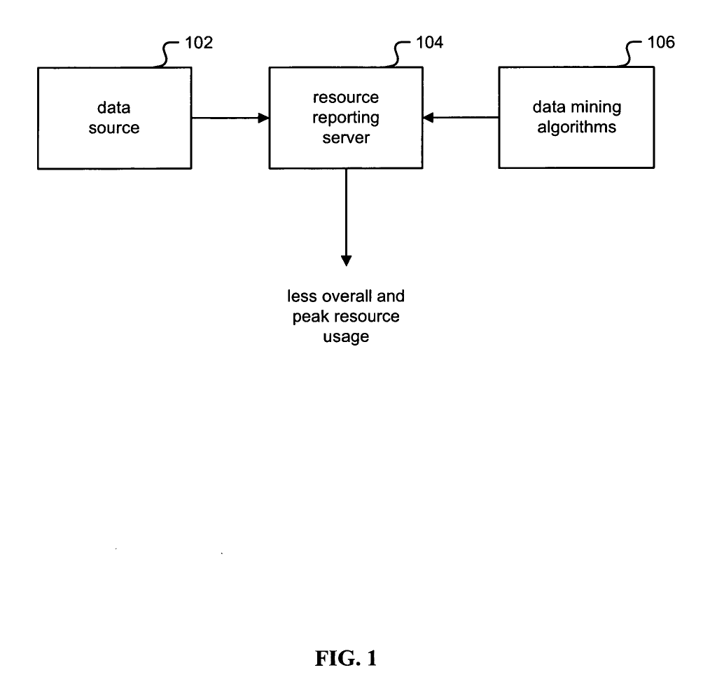

FIG. 1 illustrates a system for communicating a consumer's usage of a resource. In the example shown, one or more data sources 102 are coupled to a resource reporting server 104, along with one or more data mining algorithms 106, to motivate less overall and peak resource usage.

New technology such as Advanced Meter Infrastructure (“AMI”) allows resource distribution companies to collect consumer resource usage data several times daily, in lieu of the current standard of monthly resource use reading. Data such as AMI data can be further analyzed for more detailed and accurate assessments of consumer resource consumption behavior and installed appliances and resource consumptive devices in the home.

In various embodiments, data from data source 102 comprises one or more of:
geographic information systems (“GIS”) data, including locations from the global positioning system (“GPS”), geographic regions represented as areas surrounding (or within a fixed radius of) specific addresses, and latitude and longitude pairs;
weather data, including historical and current statistics on temperature, humidity, apparent temperature, and climate for a geographic region or aggregate;
demographic data, including address data (a street, city, county, state/province, zip+4/postal code, and/or country), designated market areas (“DMAs”), major metropolitan areas, combined statistical areas (“CSAs”), income data from private data providers, level of concern for the environment per household, status of household as homeowner/renter, and voter registration;
housing data, including government and county data recording the square foot/meter or plan area of a consumer's home, the date of construction of a consumer's home, housing orientation and shade cover and assessed value of the house;
census data including household data: ages, ethnicities, education levels, number of births and children, level of computer usage, and household income; location data: census tracts, block groups, and blocks;
billing data, including a consumer's usage or readings of: electricity, gas, water, sewer, waste, wastewater, garbage, recycling, phone, and/or network broadband access, and corresponding multiple readings per day of these utilities with advanced meters where available;
resource distribution company data on consumer interaction including customer satisfaction data and response rates to past marketing efforts online, on paper, and via the telephone; and
financial data, including a consumer's participation in rebate programs, discounted offers, and coupons from local municipal, county/prefecture and/or provincial/state governments, and businesses, and historical information on default and payment rates to resource distribution companies.

The data mining algorithms 106 include custom targeting algorithms that filter a plurality of data points across the data sources 102 to persuade a consumer to moderate resource consumption through peer comparison, and adaptive algorithms that react to feedback from the data sources 102.

In some embodiments, a custom targeting algorithm segments customer energy use through analysis of the energy use signal over time normalized to the most relevant peer group. The most relevant peer group is determined by a plurality of variables. In some embodiments the plurality of variables include proximity, house size, and house age. A normalizing process may be used to attenuate noise from the comparison so as to highlight the type of usage profile.

For sources with data collected on the order of months, users can be segmented according to their annual usage profile. Analysis may include determining heavy air conditioner usage or heavy appliance usage. For sources with data collected on the order of days or hours, data may be analyzed at a detailed level and determine specific issues such as problematic appliances or lighting contribution.

The resource reporting server 104 uses targeted direct marketing techniques to persuade a consumer to moderate resource consumption using one or more of these techniques:
segmentation of the set of consumers into different subsets based upon a plurality of demographic variables;
segmentation of the set of consumers into different subsets based upon analysis and characterization of energy usage normalized to relevant peer groups;
prioritization of the messages based upon their historical rate of uptake multiplied by the expected energy savings value of the program;
offers and services for resource efficient products discounted by private industry through rebates, coupons, and other discounts to support government subsidies of efficient products;
high quality design (using high quality print design, high quality web graphics, video, audio and other multimedia) for all data reports, dynamically customized for each consumer;
integration with an Internet site or website for online and offline viewing of reports;
scalability of report format to hundreds of millions of reports;
enabling efficacy tracking of hundreds of simultaneous marketing and messaging campaigns; and straightforward integration with resource and/or utility databases.

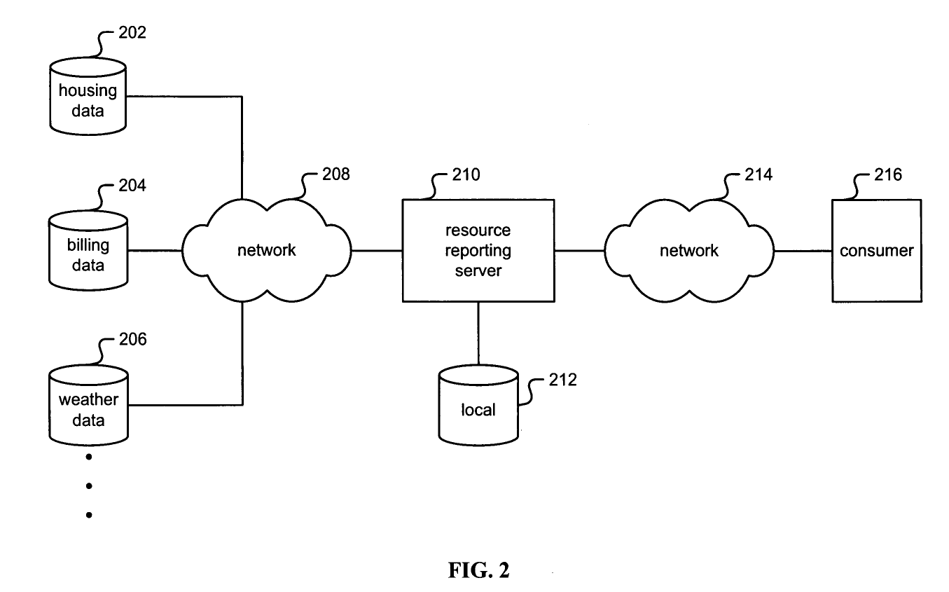

FIG. 2 is a block diagram illustrating an embodiment of a system for communicating a consumer's usage of a resource. In some embodiments, the system of FIG. 2 is included in FIG. 1. In the example shown, three data sources including housing data source 202, billing data source 204, and weather data source 206 are coupled through network 208 to resource reporting server 210. The resource reporting server 210 has a local database 212, and is also coupled through network 214 to consumer resource accounts 216. The data sources 202, 204, 206 and local database 212 are examples of a “data store” which contain resource usage information. In some embodiments the data store is a disk, tape, or storage array. In some embodiments, the data store may be one or more remote databases, one or more local databases, or span both remote and local databases.

Housing data 202 may include government and county data recording the square foot/meter or plan area of a consumer's home, the date of construction of a consumer's home, the number of floors, the presence of a garage, the presence of a pool, the assessed value of the home, and permits issued for past renovations. Billing data 204 may include a consumer's usage or readings of: electricity, gas, water, sewer, waste, wastewater, garbage, recycling, phone, and/or network broadband access, and corresponding multiple readings per day with advanced meters where available. Weather data 206 may include historical and current statistics on temperature, humidity, apparent temperature, and climate for a geographic region or aggregate related to a consumer.

Network 208 and network 214 may be a public or private network and/or combination thereof, for example the Internet, an Ethernet, serial/parallel bus, intranet, Local Area Network (“LAN”), Wide Area Network (“WAN”), and other forms of connecting multiple systems and/or groups of systems together.

Resource reporting server 210 may include one or more servers, including server 104, dedicated to processing data mining algorithms 106 to moderate resource usage of consumer 216. In some embodiments server 210 will have a local database 212 to record historical data, execute data mining algorithms 106, and/or record additional data. Consumer 216 will act and react to reports or websites from resource reporting server 210 by adjusting resource consumption and/or participating in programs such as rebate programs. These consumer reactions will indirectly or directly adjust the data in data sources 102, for example billing data source 204, and the resource reporting server 210 will dynamically adjust to the said consumer reactions.

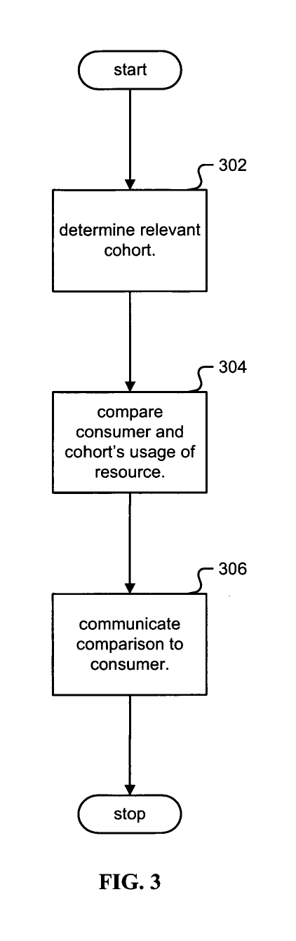

FIG. 3 is a flowchart illustrating an embodiment of a process for communicating a consumer's usage of a resource. The process may be implemented in resource reporting server 104.

In step 302, a relevant cohort is determined. A “relevant cohort” in this context is a set of one or more resource accounts sharing a common statistical and/or demographic factor with the consumer. In some embodiments, step 302 includes selecting a relevant cohort such that the consumer will be motivated to (further) moderate their resource usage, for example because their current usage compares unfavorably to other users like them. In some embodiments this step may be omitted if a relevant cohort is pre-calculated or determined externally.

In some embodiments, determining the relevant cohort comprises selecting the relevant cohort based at least in part on a determination that the consumer's usage of the resource is greater than the relevant cohort's usage of the resource. Selecting the relevant cohort in some embodiments comprises comparing the consumer's usage to that of each of a plurality of candidate cohorts and selecting as the relevant cohort the candidate cohort to which the consumer compares least favorably. In some embodiments, the consumer is compared to candidate cohorts in an iterative manner until a cohort to which the consumer compares unfavorably, if any, is found.

In some embodiments, data from third party data sources is used in determining the relevant cohort. Examples of third party data sources include records associated with home ownership, which are used to identify members of the relevant cohort based at least in part on information indicating such members own a home associated with their consumption of the resource.

In step 304, the consumer's usage and relevant cohort's usage of the resource are compared. The usage of the resource may be time-value curve or a statistical measure such as a mean, median, average, or aggregate usage. In some embodiments, the usage is chosen at least in part so that the consumer's usage of the resource is greater than the relevant cohort's usage of the resource.

In step 306, the comparison is communicated to the consumer. In some embodiments, the comparison is communicated to the consumer as part of the consumer's resource bill or on the resource's website under the consumer's web account. The communication will be dynamically selected to be efficient in motivating the consumer to moderate resource usage, based in part on feedback from previous communications.

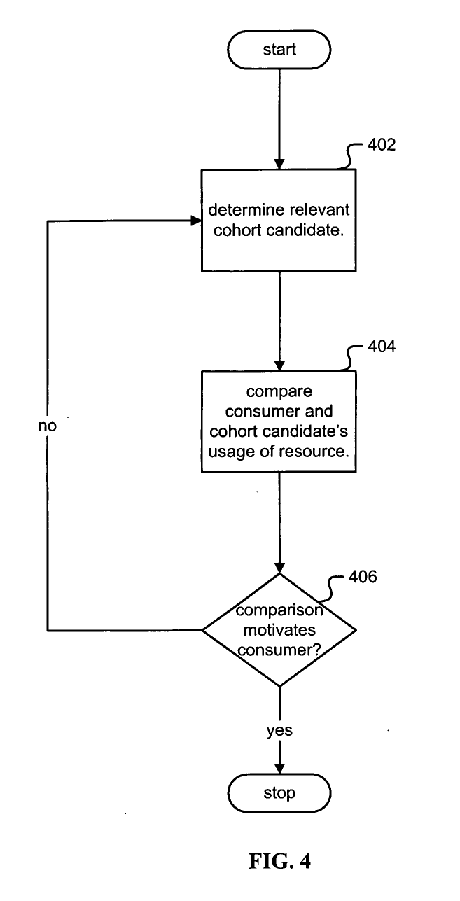

FIG. 4 is a flowchart illustrating an embodiment of a process for determining a relevant cohort. In some embodiments, the process of FIG. 4 is included in 302 of FIG. 3. The process may be implemented in resource reporting server 104.

In step 402, a relevant cohort candidate is determined. A relevant cohort candidate is a set of one or more resource accounts that share at least one common statistical factor with the consumer. In some embodiments, a relevant cohort candidate is determined at least in part by using data, for example from external and/or internal data sources, to determine one or more statistical and/or demographic factor(s) associated with the consumer and then to identify which other resources accounts, if any, also are associated with the same one or more statistical and/or demographic factor(s).

For example, property tax rolls and/or other public and/or private data sources may be checked to determine that a consumer is (or at least appears to be) the owner occupier of an 1,800 square foot three bedroom home in the 90210 postal code. One example of a relevant cohort candidate might then any resource account(s) associated with owner occupiers of 1,800 square foot homes. Another example of a relevant cohort candidate might then be any resource account(s) of three bedroom homes in the 90210 postal code. The relevant cohort candidate is determined by reviewing the data on the customer with the available data sources.

In step 404, the consumer's usage and relevant cohort candidate's usage of the resource are compared. The usage of the resource may be a statistical measure such as a mean, median, average, or aggregate usage. If it is determined in step 406 that the comparison would not motivate the consumer to moderate resource usage, for example because the relevant cohort candidate's usage of the resource is greater than the consumer's usage of the resource by a specified threshold, then the relevant cohort candidate is rejected, and control is transferred to step 402 to find a next relevant cohort candidate.

If it is determined in step 406 that the comparison would motivate the consumer to moderate resource usage, then the relevant cohort candidate is determined to be the relevant cohort for step 302.

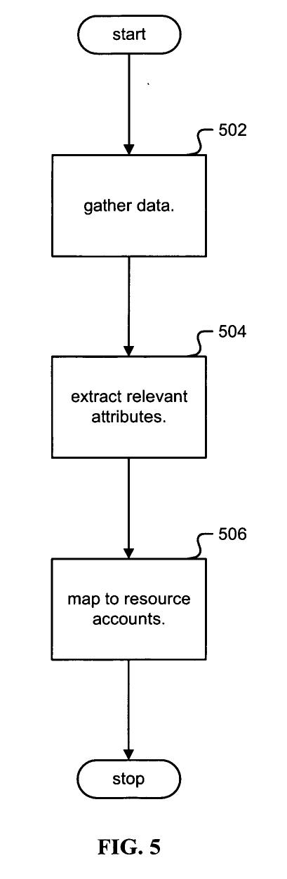

FIG. 5 is a flowchart illustrating an embodiment of a process for determining a relevant cohort candidate. In some embodiments, the process of FIG. 5 is included in 402 of FIG. 4. The process may be implemented in resource reporting server 104.

In step 502, data is gathered for the consumer and from the available data sources 102, for example 202, 204, 206. In some embodiments, the data is gathered over network 208 or from local database 212. In some embodiments, to make efficient use of the network 208, some of the data is stored in local database 212 temporarily or permanently.

In step 504, relevant attributes are extracted from both the consumer data and the available data sources 102. In some embodiments, extracting attributes may include processing data. For example, housing data and the consumer's address may be extracted to determine whether the consumer rents or owns their home, their geographic location, and the number of bedrooms in the home. If the consumer owns their home, housing data and addresses of resource accounts within a specified number of blocks of the consumer may be extracted to find other homeowners near the consumer with the same number of bedrooms.

In some embodiments, attributes may have a weighting that may be used to rank attributes. For example, using the example of finding other homeowners near the consumer, a list of relevant cohort candidates may be ranked such that that the top relevant cohort candidate is “all homeowners with three bedrooms within 50 blocks of the consumer”, the second relevant cohort candidate is “all homeowners with three bedrooms within 10 blocks of the consumer”, and the last relevant cohort candidate is “all homeowners with three bedrooms within 2 blocks of the consumer”. The ranking is made in this example to give greater motivational weight to the consumer, by assuming a consumer would be further motivated if a greater number of resource accounts compare unfavorably to the consumer. Thus, the top ranked relevant cohort candidate would be a set of a larger number of resource accounts than the last ranked relevant cohort candidate, and all ranked relevant cohort candidates are related by home size and proximity to the consumer.

In step 506, the top relevant cohort candidate of step 504 is mapped to other resource accounts. For example, if the top relevant cohort candidate is “all homeowners with three bedrooms within 50 blocks of the consumer”, and there are 234 resource accounts within this cohort, a mapping will be created to link each of the 234 resources accounts to the corresponding relevant cohort candidate within the available data sources 102.

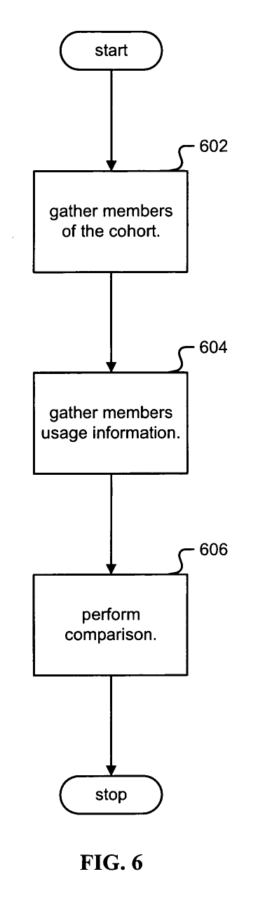

FIG. 6 is a flowchart illustrating an embodiment of a process for comparing a consumer's resource usage with a relevant cohort candidate. In some embodiments, the process of FIG. 6 is included in 404 of FIG. 4. The process may be implemented in resource reporting server 104.

In step 602, the members of the relevant cohort candidate are determined. In some embodiments, the mapping from step 506, and data sources 102, 202, 204, 206 and 212 are used to assist determining the members.

In step 604, the resource usage information of the members of the relevant cohort candidate is determined. The resource usage information may be determined as a time-value curve, or a statistical representation such as a mean, median, average, or aggregate usage. The consumer's resource usage information is also determined.

In step 606, the relevant cohort candidate's resource usage information is compared to the consumer's resource usage information. In some embodiments, one or more statistical representations are made on both the relevant cohort candidate's resource usage over time and/or across members, and the consumer's resource usage over time. In some embodiments, several comparisons are performed to determine which comparison basis results in the consumer comparing most unfavorably to the candidate cohort.

For example, a consumer's mean usage may be 50 watts, and median usage may be 52 watts, while a relevant cohort candidate's mean usage across all members may be 45 watts, and median usage may be 42 watts. In this example, two comparisons are made to show that while the consumer's mean usage is only 11% greater than that of the cohort, the consumer's median usage is 23% greater. It may be determined that the median comparison will motivate the consumer to moderate resource usage more than the mean comparison because the numbers are larger.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1-25. (canceled)

26. A computerized method for reporting a first consumer's usage of a resource, the method comprising:
in a first computer process, retrieving information about a first consumer and a plurality of second consumers, the information including housing data and resource usage data;
in a second computer process, selecting at least one relevant consumer from the plurality of second consumers, the at least one relevant consumer being selected based, at least in part, on:
at least two common characteristics between the first consumer's home and the relevant consumer's home, and
a determination that the first consumer's resource usage is greater than the relevant consumer's resource usage;
in a third computer process, generating a report based on a comparison of the first consumer's resource usage data to the at least one relevant consumer's resource usage data; and
communicating the report to the first consumer.

27. A method according to claim 26, wherein the at least two common characteristics are location of the homes and area of the homes.

28. A method according to claim 26, wherein the at least two common characteristics are selected from the group consisting of:
location of the homes,
area of the homes,
number of bedrooms in the homes,
number of floors of the homes,
date of construction of the homes,
assessed home value of the homes,
permits issued for past renovations of the homes,
number of people living in the homes,
presence of a garage in the homes, and
presence of a pool in the homes.

29. A method according to claim 26, wherein the resource usage data comprises one or more of electrical usage data and gas usage data.

30. A method according to claim 26, wherein the resource usage data comprises one or more of electrical usage data, gas usage data, waste usage data, water usage data, sewer usage data, garbage usage data, recycling usage data, phone usage data, and broadband access usage data.

31. A method according to claim 26, further comprising:
receiving resource usage data of the plurality of second consumers from each of their respective resource usage meters.

32. A method according to claim 31, wherein the resource usage meters are part of an advanced metering infrastructure.

33. A method according to claim 26, wherein the report is communicated over a computer network.

34. A method according to claim 33, wherein the report is communicated to the first consumer over a website.

35. A method according to claim 26, wherein the resource usage data includes at least one of a time value curve, a mean usage, a median usage, an average usage, and an aggregate usage.

36. A method according to claim 26, wherein selecting the at least one relevant consumer comprises:
comparing the first consumer's resource usage data to a second consumer's resource usage data;
if the first consumer's resource usage is greater than the second consumer's resource usage, selecting the second consumer as the relevant consumer; and
if the first consumer's resource usage is not greater than the second consumer's resource usage, comparing the first consumer's resource usage data to another second consumer's resource usage data;
wherein the comparing is iteratively performed until a relevant consumer is selected.

37. A method according to claim 26, further comprising:
comparing the first consumer's resource usage data to a plurality of second consumers' resource usage data; and
selecting as the relevant consumer a second consumer to which the first consumer's resource usage compares least favorably.

38. A method according to claim 26, wherein at least some of the second consumer information is retrieved from third party data sources.

39. A method according to claim 38, wherein at least some of the second consumer information retrieved from third party data sources is home ownership records.

40. A method according to claim 39, wherein the home ownership records are used to match second consumers to homes associated with the second consumers' resource usage.

41. A method according to claim 26, wherein the report is communicated to the first consumer as part of the first consumer's resource bill.

42. A system for reporting a first consumer's usage of a resource, the system comprising:
a data store for storing information about a first consumer and a plurality of second consumers, the information including housing data and resource usage data; and
a processor configured to retrieve the information about the first consumer and the plurality of second consumers from the data store;
wherein the processor is configured to select at least one relevant consumer from the plurality of second consumers, the at least one relevant consumer being selected based, at least in part, on:
at least two common characteristics between the first consumer's home and the relevant consumer's home, and
a determination that the first consumer's resource usage is greater than the relevant consumer's resource usage;
wherein the processor is configured to generate a report based on a comparison of the first consumer's resource usage data to the at least one relevant consumer's resource usage data and communicates the report to the first consumer.

43. A system according to claim 42, wherein the processor is a server.

44. A system according to claim 42, wherein the processor is in communication with a computer network and the processor is further configured to communicate the report over the computer network to the first consumer.

45. A system according to claim 42, wherein the at least two common characteristics are location of the homes and area of the homes.

46. A system according to claim 42, wherein the at least two common characteristics are selected from the group consisting of:
location of the homes,
area of the homes,
number of bedrooms in the homes,
number of floors of the homes,
date of construction of the homes,
assessed home value of the homes,
permits issued for past renovations of the homes,
number of people living in the homes,
presence of a garage in the homes, and
presence of a pool in the homes.

47. A system according to claim 42, wherein the resource usage data comprises one or more of electrical usage data and gas usage data.

48. A system according to claim 42, wherein the resource usage data comprises one or more of electrical usage data, gas usage data, waste usage data, water usage data, sewer usage data, garbage usage data, recycling usage data, phone usage data, and broadband access usage data.

49. A system according to claim 42, wherein the processor is further configured to receive at least some of the resource usage data from resource usage meters.

50. A system according to claim 42, wherein the processor is in communication with an advanced metering infrastructure.
